(19) United States
(12) Patent Application Publication
(10) Pub. No.: US 2012/0102796 A1
(43) Pub. Date: May 3, 2012

(54) DISPLAY MODULE FOR VECHILES

(76) Inventor: Yacine Kara, Paris (FR)

(21) Appl. No.: 13/375,591

(22) PCT Filed: Jun. 3, 2010
(86) PCT No.: PCT/EP10/57803

§ 371 Date: Jan. 10, 2012

(30) Foreign Application Priority Data
Jun. 3, 2009 (FR) 09 53660

(51) Int. Cl. G09F 11/29; G09F 13/02; H05B 37/02; G09F 21/04

(52) U.S. Cl. 40/515; 315/152

(57) ABSTRACT

The present invention relates to a display module for a vehicle, having a mounting fastened to the vehicle and having a display suitable for unwinding under the action at least one motor (7) connected to a drive shaft (6) in engagement with the display for the purpose of unwinding it; and a cover (2) mounted on the mounting (1) so as to close said display module; a management device (11) controlling the motor for the purposes of stopping, starting, and changing their unwinding speed, and controlling lighting of the display (5); said display module having LEDs in front of the display (5), on at least two sides of the display (5), and a reflective wall, disposed behind the display (5), to reflect the lighting produced by the LEDs.

### BACKGROUND OF THE INVENTION

The present invention relates to a display module for vehicles. More particularly, the invention relates to a display module for unwinding a display of advertising, of a photograph, or of any other type of visual element on a vehicle.

Currently, advertising vehicles are known that have one or more static portions dedicated to presenting a poster. Such vehicles may be passenger automobiles and the poster is then pasted or affixed directly onto the bodywork of the vehicle, or indeed, more often, the vehicle is a high-sided vehicle having one or more panels used for such display.

A major drawback with that type of display is that it consists of a poster pasted on or affixed to a panel that is optionally lit by one or more spotlights. Such spotlights are positioned in front of or on the side of the panel, and it is therefore necessary to provide a considerable amount of space on the vehicle for accommodating the spotlights. Thus, such display modules occupy a large volume on the vehicle, generally requiring the vehicle to be altered considerably and therefore giving rise to high costs.

In addition, in the rare configurations when such display devices have lighting that is incorporated into the display module, such lighting is necessarily voluminous, resulting in the display module having large thickness making it very difficult to use for vehicles that are not specifically arranged for that purpose. In addition, certain regulatory obligations require the thickness of such display devices to be reduced.

Furthermore, regardless of the zone though which the vehicle travels and regardless of the people who can potentially see the panel, the display remains the same. Even though such a display device sometimes makes it possible to unwind the display, such unwinding being arranged to take place automatically, i.e. a particular poster is visible for a predetermined lapse of time, without taking account of the place in which the vehicle is situated, and thus of the target people who are, in general, more or less sensitive to a particular visual depending on the place through which the vehicle is passing.

### BRIEF SUMMARY OF THE INVENTION

An object of the invention is to remedy those drawbacks by proposing a display module for a vehicle, which display module comprises:
a mounting fastened to the vehicle and having a display suitable for unwinding under the action of means for unwinding; and
a cover mounted on the mounting so as to close said display module;

the means for unwinding comprising at least one motor connected to a drive shaft in engagement with the display for the purpose of unwinding it;

a management device controlling the means for unwinding for the purposes of stopping them, of starting them, and of changing their unwinding speed, and controlling means for lighting of the display;

said display module being characterized in that said means for lighting consist of light-emitting diodes (LEDs) present, in front of the display, on at least two sides of the display, and of a reflective wall, disposed behind the display, and designed to reflect the lighting produced by the LEDs.

By means of the invention, the means for lighting are specially designed to enable optimum lighting of the display to be achieved, while also allowing the thickness of the display module to be much smaller than the thickness of prior art devices, and while making it easy for the display module to be mounted on a vehicle without making significant alterations to the vehicle.

In a particularly advantageous second aspect of the invention, the management device comprises means for geographical positioning of the Global Positioning System (GPS) type, and a memory that stores the display that is to be presented by the module as a function of its geographical position, the geographical positioning information from the means for positioning being sent to the memory so that the management device can determine the appropriate display, as a function of said positioning information.

Thus, the display presented by the module is established as a function of the places through which the vehicle passes, as determined by its geographical position compared with the geographical position that is recorded in the memory of the management device and that corresponds to one or more determined displays.

The display module of the invention is ideally fastened to the outside of the vehicle, on one of the sides thereof, so as not to obstruct the driver's visibility.

By means of the display module of the invention, a user can easily access the display so as to change it or so as to repair/alter any one of the elements present in the display module.

Other characteristics appear from the description of an embodiment of the invention:
in a preferred embodiment of the invention, the means for unwinding comprise at least two motors, each of which is connected to a respective drive shaft, the drive shafts being in engagement respectively with the top portion and with the bottom portion of the display;
in a possibility offered by the invention, the two motors are controlled independently; in this way, when the top motor stops turning, the bottom motor can turn to a small extent (e.g. through one quarter of a turn) in the direction opposite to the direction of turning of the display (which turning direction is determined by convention) so as to tension the display between the two drive shafts;
in a first variant embodiment, the display module comprises means for linking, consisting, for example, of telescopic tubes, between the mounting and the cover so that the cover is suitable for pivoting away from the mounting through an angle of not less than 30°;
in a second variant embodiment, the cover is mounted to be static on the mounting and only a bottom portion is mounted to move relative to the mounting, so as to open the display module and alter the posters presented;
the display module is powered by at least one battery, optionally connected to a set of solar collectors for the purpose of charging it;
advantageously, the display module comprises at least one position sensor for sensing the position of the display, which position sensor is connected to the management device for the purpose of transmitting information about the position of the display;
the cover comprises a transparent portion enabling the display to be seen, and preferably made of a plastics material;
preferably, the management device comprises means for receiving suitable for receiving signals from means for controlling, such as a remote control having a push button, for the purpose of controlling said management device;
in a possibility offered by the invention, the display module further comprises at least one light sensor that transmits light-level information to the management device that, in return, controls the brightness of the lighting from said means for lighting; and
the mounting and the cover are made up of a metal frame that is preferably made of aluminum.

### BRIEF DESCRIPTION OF THE DRAWINGS

The invention is described below in more detail with reference to non-limiting figures that show merely a preferred embodiment of the invention, and in which:

FIG. 1 is a diagrammatic plan view of the display module of the invention;

FIG. 2 is a side section view of a display module of the invention;

FIG. 3 is a side view of the display module of FIG. 2 in an embodiment when the cover is moved some distance away from the mounting;

FIG. 4 is a front view of a display module in a second embodiment in which the cover forming the module consists in a single bottom portion, at least a segment of which is movable so that an operator can access the display;

FIG. 5a is a side view of the bottom portion forming the cover that is suitable for opening by pivoting away from the display module, when said portion is closed;

FIG. 5b is a side view of the bottom portion shown in FIG. 5a when a segment of said bottom portion is open;

FIG. 6 is a diagrammatic perspective view of a display module in the embodiment shown in FIGS. 4, 5a, and 5b mounted on the side of a vehicle; and

FIG. 7 is a view partially in section showing how the display module is fastened.

### DETAILED DESCRIPTION OF THE INVENTION

The display module is of square or of rectangular geometrical shape, but naturally its shape and its dimensions depend on the type of vehicle used. By means of the invention, the thickness of the display module is no greater than 10 centimeters (cm), and generally lies approximately in the range 5 cm to 10 cm. For example, the display module may have the following dimensions: a width of 120 cm, a height of 100 cm, and a thickness of 7 cm.

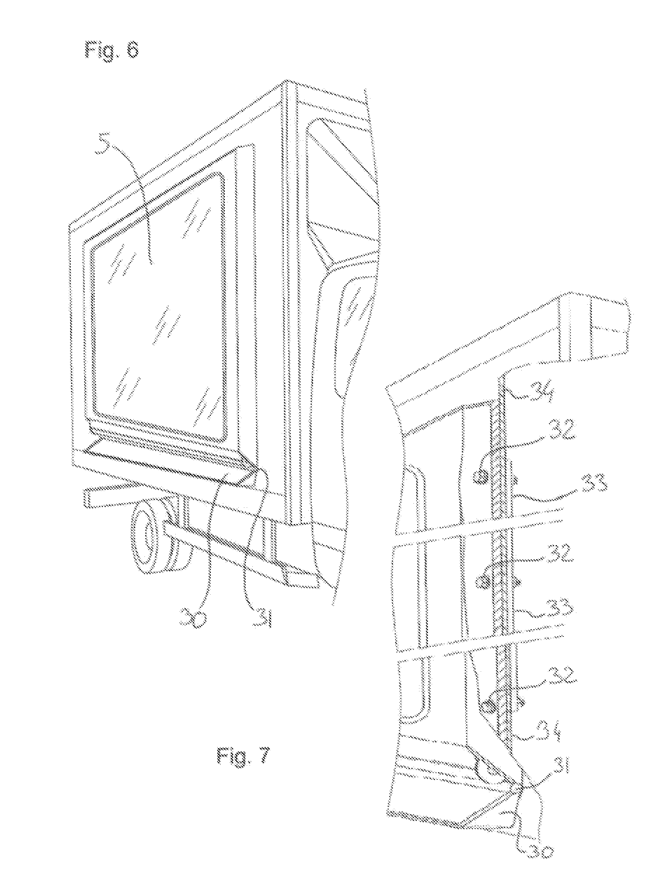

The display module is composed of a mounting 1 designed to be fastened to the vehicle, which is, in particular, a truck or a public transport vehicle such as a bus, as shown in FIG. 6. When the vehicle is a truck or a bus, or more generally when it is a vehicle having large plane side surfaces, it is particularly easy to mount the display module on the vehicle. It is possible merely to fasten the module by means of a plurality of screws 32 or the like directly to one or more plane surfaces of the vehicle. Optionally, as shown in FIG. 7, a reinforcing plate 33 may be provided that is designed for mechanically reinforcing the wall 34 of the vehicle on which the display module mounting is fastened.

For a vehicle having one or more side surfaces of smaller size, the display module may, in turn, be of smaller size and/or the mounting 1 may be fastened to the vehicle by adapting or altering slightly the outside structure of the vehicle by forming an attachment device on which the mounting 1 can be mounted/attached.

The mounting 1 comprises a metal framework that is preferably made of aluminum and to which complementary segments made of plastic are fastened, or else the framework is made entirely of aluminum. Thus, the weight of the display module is relatively small.

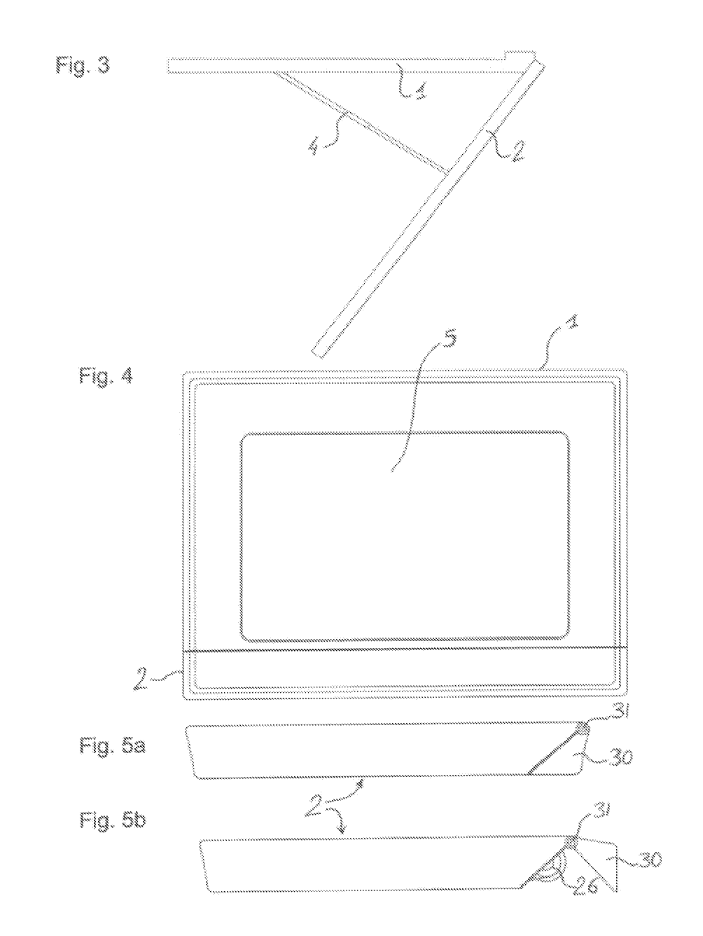

In a possibility offered by the invention and shown in FIG. 3, a cover 2 is fastened to the mounting 1 via a hinge 3 that is situated at one end of the mounting 1, so that the cover 2 is mounted to pivot on the mounting 1 and can be moved away therefrom 1 through an angle that is not less than 30°, and that is preferably greater than 60°. In this example, the mounting 1 is connected to means for linking 4, e.g. consisting of telescopic tubes or rods, designed to guide the cover 2 as it moves away from the mounting 1. In the example shown to illustrate the invention, the means for linking 4 consist of two telescopic tubes situated in the vicinities of respective ones of two opposite sides of the mounting 1. When the display module is closed, i.e. when the cover 2 is shut against the mounting 1, said two telescopic tubes 4 extend parallel to two opposite edges of the module.

In a variant embodiment, shown in FIGS. 4 to 6, the cover 2 is mounted to be static on the mounting 1, and only a bottom segment 30 of the cover 2 may be withdrawn (by it being mounted removably or pivotally) so as to allow an operator to manipulate the display 5 and to alter/replace the posters therein. This variant embodiment offers the advantage of imparting improved weatherproofing to the module due to the presence of a single opening in a bottom/low position on the device. This system also offers the advantage of being quite safe, so that, even in the event that the bottom segment 30 opens accidentally, there is no danger for other road users. The cover 2 consists in the bottom portion that is fastened to the module to form the bottom end thereof. In the example chosen to show this portion 2, only a segment or a panel 30 thereof is mounted to pivot about an axis 31 that, in this example, is on the front face of the module. Advantageously, by opening, the panel 30 masks the top portion of the opening making it possible to access the display 5 so that said display is protected from outside water, even in the event of a shower. The panel 30 can thus be moved away from the remainder of the bottom portion 2 and the operator can access the actuator arm 26 in which the display 5 is engaged. By turning the actuator arms 6, 26 via the motor 7, 27, or optionally manually, the operator can access all of the posters present in the display 5 and remove them/replace them. When it is in the closed position, as shown in FIG. 5a, the panel 30 may be locked/unlocked either by a conventional mechanical system by means of a key, or electrically by using an electrical control.

In this example, the display 5 consists in a roll, e.g. a roll made of a plastics material, and sufficiently flexible and strong to be driven in rotation by the drive shafts 6, 26 coming from respective motors 7, 27. This plastics strip constituting the display 5 may have a plurality of locations provided with grooves for inserting a poster therein or for removing a poster therefrom, so that by opening all or some segment of the cover 2, it is easy to replace the various posters presented.

The display roll 5 extends substantially linearly and in engagement at its opposite ends in respective ones of the arms 6 and 26. The top arm 6 is the shaft of the motor 7 and it is thus driven in rotation by said motor 7, while the bottom arm 26 is the shaft of the motor 27 that drives it in rotation. The management device 11 controls the speed of rotation of the shafts 6, 26 via the motors 7, 27. In the embodiment shown in the accompanying figures, the display module has two motors 7, 27 with drive shafts 6, 26 placed respectively in a top position and in a bottom position. Naturally, it is possible to make provision for the display module to have more than two drive motors, e.g. four or eight drive motors, when the display 5 is particularly large and/or heavy. In this example, the two motors 7, 27 operate together to unwind the display 5 in one direction or the other, and provision may advantageously be made to stop the top motor 7 when the display is in place while the second motor 27, i.e. the bottom motor, turns for a very short time in the opposite direction (the direction opposite to the unwinding direction of the display, chosen arbitrarily to be clockwise or counterclockwise) so as to tension the display 5 properly between the two drive shafts, namely the top and bottom drive shafts. Tensioning the display 5 makes it possible to avoid movements that jam or crease the posters when traveling on roads in a poor state, e.g. when the road surface has humps and potholes.

Each of the drive shafts 6, 26 of the motors 7, 27 is advantageously associated with a shaft 9 that can be driven in rotation or that is free to rotate, that is situated such that it bears against the drive shaft 6, 26 of the motor 7, 27, and that is designed to press the display roll 5 and to constrain its movement.

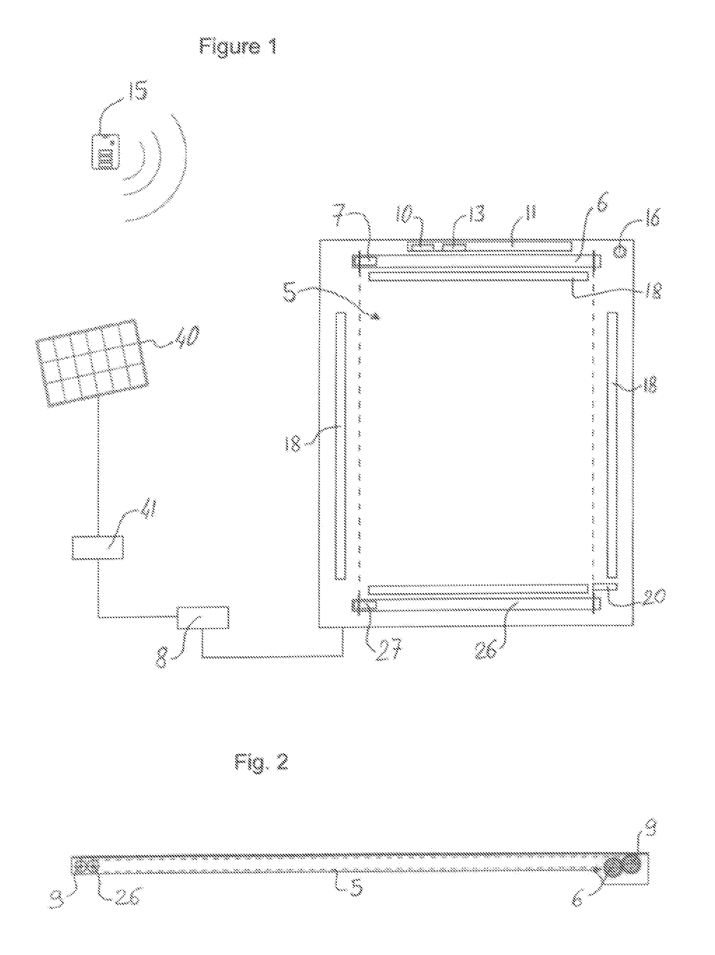

The motors 7, 27 and all of the electrical/electronic equipment of the display module are ideally powered by a battery 8 that may be charged while the vehicle is traveling, like the conventional battery of the vehicle, by being connected to said conventional battery. As shown in FIG. 1, it is also possible to make provision for said battery 8 to be connected to solar collectors 40, via a solar regulator 41 (necessary for charging the battery and for stabilizing the output voltage), which collectors are suitable for storing solar energy and for transforming it into electrical energy stored by the battery 8.

The means for positioning 10 are advantageously placed in the management device 11 and they make it possible to indicate the geographical position of the vehicle to a memory unit, containing the information about desired display as a function of determined geographical position, which memory unit is also disposed in the management device 11 so that the assembly comprising the means for positioning and the memory communicates merely by wire. Naturally, it is also possible to make provision for the memory to be situated remote from the management device 11 and for it to communicate with said management device 11 via wireless links, e.g. via radio links. Thus, a position of the vehicle is located by the geo-location means 10, and this information is transmitted to the memory unit that compares said information with the display data corresponding to this geographic position, so as to indicate to the management device 11 which one of the plurality of posters in the display 5 is appropriate for being seen in this geographical zone.

The display module is also provided with a receiver unit 13 connected to the management device 11 so that said management device can communicate with the outside and in particular optionally be controlled by a remote user/operator by means of a remote control or from a central station 15. Naturally, the remote control or the central station 15 is available to the user with an interface adapted to enable said user to control the management device 11 as desired and thus to control all of the functions managed by said device. In the same way, it is possible to make provision for the driver or for a passenger of the vehicle to control the management device 11 so as to unwind the posters and/or so as to control lighting of them, it being possible for the link between the control module 15 of this person and the management device 11 to be a wired link.

The display module also has at least one light sensor 16 making it possible to determine the level of the surrounding light and to act, via information transmitted to the management device 11, to adapt correspondingly the brightness of the means for lighting 18 present on the mounting 1 and designed to light the display 5. Thus, when the light sensor 16 detects bright light, the management device 11 switches off the means for lighting 18, whereas when the light sensor 16 detects dim surrounding light, the information transmitted to the management device 11 causes the brightness of the light produced by the means for lighting 18 to be increased, e.g. average level of surrounding light causes half the means for lighting 18 to operate whereas no surrounding light and maximum level of surrounding light respectively cause all of the means for lighting 18 to operate and all of the means for lighting 18 to be switched off.

The means for lighting 18 consist of LEDs that are disposed in rows on either side of the display 5 so as to produce uniform lighting. In the example chosen to illustrate the invention, the LEDs are present on all sides of the display 5 (top, bottom, right and left), in front of said display, while a reflective surface or wall (not shown in the accompanying figures) is disposed behind the display 5, e.g. adhesively bonded thereto or disposed at some distance (a few millimeters) therefrom and fastened to the mounting 1 of the display module. Said reflective wall can reflect diffusely, i.e. the surface of the reflective wall is not uniform, resulting in the light being reflected off said surface in a large number of directions and the energy of the incident ray being redistributed into a multitude of reflected rays. The reflective wall may also be a specular reflector, i.e. an incident ray then results in a single reflected ray of substantially identical energy. The reflective wall is made of a metal material, e.g. of aluminum, or of any material that is suitable for achieving total reflection of the light, be that reflection diffuse or specular.

The management device 11 comprises, in conventional manner, a Central Processing Unit (CPU) suitable for processing the information received from the various elements 7, 10, 13, 16, 27 of the display module and for sending commands to said various elements 4, 7, 18, 27.

It should be noted that the display module of the invention is particularly suitable for “clean” vehicles, namely for electric vehicles or for hybrid vehicles, in particular so as to recoup some of the price of this type of vehicle that is often high compared with the prices of vehicles from the conventional ranges.

In operation, the display module of the invention is fastened to one of the sides of a vehicle. The vehicle preferably travels through a built-up zone, the means for positioning 10 informing the management device 11 of the position of the vehicle and optionally that it is approaching a particular geographical zone so that the display 5 is altered (unwound by means of at least one motor 7 or 27) so as to present a new poster.

In the same way, if the light sensor 16 detects the vehicle is going through a dark zone, e.g. when the vehicle enters a tunnel, this information is transmitted to the management device 11 so that said management device 11 causes the brightness of the means for lighting 18 to increase (or causes the number of them that are on to increase). Conversely, as soon as the light sensor 16 detects surrounding light that is brighter, e.g. on exiting from a tunnel, that information is also transmitted to the management device 11 which causes the brightness of the means for lighting 18 to be reduced (or some of them to be switched off).

The display module of the invention is advantageously provided with a position sensor 20 for sensing the position of the display 5 and designed to transmit information to the management device 11 so as to indicate which poster is currently visible and its location relative to the frame of the display module. By means of this information, the management device 11 can stop the motors 7, 27 turning the display roll 5, or possibly slow them down if the poster is approaching its final position, or indeed even cause them to rotate in the opposite direction so as to re-position the poster on view at the desired location.

1. A display module for a vehicle, which display module comprises:
a mounting (1) fastened to the vehicle and having a display (5) suitable for unwinding under the action of means for unwinding (6, 7, 8, 9); and
a cover (2) mounted on the mounting (1) so as to close said display module;
the means for unwinding (6, 7, 8, 9) comprising at least one motor (7) connected to a drive shaft (6) in engagement with the display for the purpose of unwinding it;
a management device (11) controlling the means for unwinding (6, 7, 8, 9) for the purposes of stopping them, of starting them, and of changing their unwinding speed, and controlling means for lighting (18) for lighting the display (5);
wherein said display module is characterized in that said means for lighting (18) consist of LEDs present, in front of the display (5), on at least two sides of the display (5), and of a reflective wall, disposed behind the display (5), and designed to reflect the lighting produced by the LEDs.

2. The module according to claim 1, wherein the module comprises means for linking (4), consisting, for example, of telescopic tubes, between the mounting (1) and the cover (2) so that the cover (2) is suitable for pivoting away from the mounting (1) through an angle of not less than 30°.

3. The module according to claim 1, wherein the cover (2) is mounted to be static on the mounting (1) and only a bottom portion (30) is mounted to move relative to the mounting (1).

4. The module according to claim 1, wherein the means for unwinding (6, 7, 8, 9) comprise at least two motors (7, 27), each of which is connected to a respective drive shaft (6), the drive shafts (6, 26) being in engagement respectively with the top portion and with the bottom portion of the display (5).

5. The module according to claim 1, wherein the management device comprises means for geographical positioning (10) of the GPS type, and a memory that stores the display that is to be presented by the module as a function of its geographical position, the geographical positioning information from the means for positioning (10) being sent to the memory so that the management device (11) can determine the appropriate display (5), as a function of said positioning information.

6. The module according to claim 1, wherein the module is powered by at least one battery (8), optionally connected to the vehicle for the purpose of charging it while the vehicle is operating, and/or connected to a set of solar collectors for the purpose of charging it.

7. The module according to claim 1, wherein the module comprises at least one position sensor (20) for sensing the position of the display (5), which position sensor is connected to the management device (11) for the purpose of transmitting information about the position of the display (5).

8. The module according to claim 1, wherein the cover (2) comprises a transparent portion enabling the display (5) to be seen, and preferably made of a plastics material.

9. The module according to claim 1, wherein the means for lighting (18) comprise a plurality of LEDs disposed on the mounting (1) on at least two opposite sides of the display (5).

10. The module according to claim 1, wherein said module is characterized in that the management device (11) comprises means for receiving (13) suitable for receiving signals from means for controlling, such as a remote control having a push button, for the purpose of controlling said management device (11).

11. The module according to claim 1, wherein the module further comprises at least one light sensor (16) that transmits light-level information to the management device (11) that, in return, controls the brightness of the lighting from said means for lighting (18).

12. The module according to claim 1, wherein the mounting (1) and the cover (2) are made up of a metal frame that is preferably made of aluminum.
